(19) United States
(12) Patent Application Publication
(10) Pub. No.: US 2005/0142444 A1
(43) Pub. Date: Jun. 30, 2005

(54) Non-aqueous electrolyte secondary cell

(76) Inventor: Satoshi Nagashima, Kyoto-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/511,090

(22) PCT Filed: Apr. 17, 2003
(86) PCT No.: PCT/JP03/04857

(30) Foreign Application Priority Data
Apr. 18, 2002 (JP) 2002-116555

(51) Int. Cl. H01M 4/52; H01M 4/50

(52) U.S. Cl. 429/231.1; 429/223; 429/231.3; 429/224; 429/231.6; 429/231.5

(57) ABSTRACT

The present invention aims to improve cycling characteristics with maintaining high capacity, which is a feature of lithium-nickel composite oxide, and provides a non-aqueous electrolyte secondary battery comprising a positive electrode which is configured by applying on a current collector a mixture which comprises: a lithium-containing composite oxide having a hexagonal system structure, wherein Co is substituted for part of nickel in a lithium-nickel composite oxide (the substitution percentage ranges from 5 to 30%) and, in addition, at least one kind of such elements as Al, Mn, Ti, and Mg is substituted (the substitution percentage is less than 20%); a binder; and a conductive material; and said lithium-containing composite oxide is characterized in that a half width of the (110)-plane-based diffraction peak obtained from powder X-ray diffraction method, in which CuKα line is used as characteristic X-ray, is larger than 0.13° and smaller than 0.20°, and that the ratio of the (003)-plane-based diffraction peak intensity to the (104)-plane-based diffraction peak intensity is larger than 1.2 and smaller than 1.8.

### TECHNICAL FIELD

The present invention relates to a non-aqueous electrolyte secondary battery in which a lithium-containing composite oxide having a hexagonal system structure is used as a positive active material.

### BACKGROUND ART

In a non-aqueous electrolyte secondary battery where a lithium-containing composite oxide having a hexagonal system structure is used as a positive active material, there is a possibility that a deep charge can be provided and high capacity can be attained. However, at present, such a battery has a problem of lacking in the stability of the positive active material, which causes a difficulty in manufacturing a battery having performance up to our expectations.

In this respect, there have been attempts to improve stability by forming a solid solution of a lithium-cobalt composite oxide and a lithium-nickel composite oxide. One example of such attempts was laid open under Provisional Publication No. 35492 of 2001.

However, even with the use of the active material which was described in the above patent gazette, capacity characteristics and cycling characteristics were still unsatisfactory.

The object of the present invention is to provide a non-aqueous electrolyte secondary battery having high capacity and excellent cycling characteristics.

### DISCLOSURE OF THE INVENTION

In general, lithium cobalt oxide having higher crystalline quality is considered to have higher capacity. Excessively high crystalline quality, however, could be subject to phase transition. This is thought to be caused by the strain of layer structure which easily occurs because of lithium undoping behavior during charge.

In a composite oxide of a solid solution of cobalt and nickel, in contrast, the strain of layer structure hardly occurs from lithium undoping behavior during charge. Such a phenomenon in this material is attributed to the behavior of nickel atoms; that is, the occurrence of any collapse in crystal structure causes a nickel atom to align along lithium plane, so that the nickel atom serves as a pillar in lithium undoping behavior.

With due consideration of these phenomena and in an attempt to prepare a lithium-containing composite oxide which has high capacity and excellent cycling characteristics, it was considered important to balance the degree of crystalline quality with the degree of layer structure collapse in the nickel atom substitution. And, as a guide to represent such balance, it was found possible to adopt the ratio of the (003)-plane-based diffraction peak obtained from X-ray diffraction to the (104)-plane-based diffraction peak. The diffraction peak based on (003) plane clearly appears when crystalline quality is high, and the diffraction peak based on (104) plane reflects the collapse of crystal structure.

As a result of intensive research, the present inventor has found that a battery having excellent capacity characteristics and cycling characteristics can be provided by using a composite oxide where the ratio of the (003)-plane-based diffraction peak intensity to the (104)-plane-based diffraction peak intensity lies in a given range, and come to complete the present invention.

More specifically, the present invention provides a non-aqueous electrolyte secondary battery comprising a positive electrode which is configured by applying on a current collector a mixture which comprises: a lithium-containing composite oxide having a hexagonal system structure, wherein Co is substituted for part of nickel in a lithium-nickel composite oxide (the substitution percentage ranges from 5 to 30%) and, in addition, at least one kind of such elements as Al, Mn, Ti, and Mg is substituted (the substitution percentage is less than 20%); a binder; and a conductive material; and said lithium-containing composite oxide is characterized in that a half width of the (110)-plane-based diffraction peak obtained from powder X-ray diffraction method, in which CuKα line is used as characteristic X-ray, is larger than 0.130 and smaller than 0.200 and that the ratio of the (003)-plane-based diffraction peak intensity to the (104)-plane-based diffraction peak intensity is larger than 1.2 and smaller than 1.8.

The (110)-plane-based diffraction peak obtained from powder X-ray diffraction method using CuKα line appears usually at 2θ=65±1°, the (003)-plane-based diffraction peak at 2θ=19±1°, and the (104)-plane-based diffraction peak at 2θ=45±1°. Furthermore, it doesn't matter whether the above-specified characteristics of diffraction peak are satisfied in a raw material state before battery production or in a charged/discharged state after battery production.

When Al is used as a previously-described element to be substituted for part of Ni, the following favorable effects can be obtained: excellent heat-resistance results in improvement of battery safety, the charge/discharge cycle stability of battery becomes better, and capacity reduction in rapid charge/discharge is controlled. When Ti or Mn is used, likewise, excellent heat-resistance causes battery safety to improve. When Mg is used, the charge/discharge cycle stability of battery improves and a high discharge voltage is possible. Especially, it is preferable to use at least one of such elements as Al and Mn, and Al is more preferable.

### BRIEF DESCRIPTION OF THE DRAWINGS

FIG. 1 is a cross-sectional view of a non-aqueous electrolyte secondary battery in accordance with an embodiment of the present invention.

FIG. 2 is an X-ray diffraction diagram of a lithium-containing composite oxide synthesized in Example 1.

FIG. 3 is an X-ray diffraction diagram of a lithium-containing composite oxide synthesized in Comparative Example 1.

FIG. 4 is an X-ray diffraction diagram of a lithium-containing composite oxide synthesized in Comparative Example 2.

FIG. 5 is a graph showing discharge curves at the 1^{st} cycle obtained from Example 1, Comparative Example 1, and Comparative Example 2, respectively.

FIG. 6 is a graph showing the relationship between the number of charge/discharge cycles and the discharge capacity obtained from cycle tests.

FIG. 7 is a graph showing the relationship between the number of charge/discharge cycles and the discharge capacity retention obtained from cycle tests.

### PREFERRED EMBODIMENTS OF THE INVENTION

The preferable lithium-containing composite oxide used in the present invention is represented by the general equation, Li_{w}NiₓCoₒM_{z}O₂ ( where M is at least one element to be selected out of Al, Mn, Ti, or Mg, 0<w≦1.2, 0.95≦x+y+z≦1.05≦x≦0.9, 0.05≦y≦0.3, and 0<z≦0.2.)

As a range of x, 0.5≦x≦0.9 is given in the above general equation, because adopting x<0.5 and 0.9<x is not preferable, respectively; in the former range, the initial capacity of battery becomes small, and in the latter range, the thermal stability of battery decreases and also the durability of charge/discharge cycle decreases. In order to make the capacity as large as possible and provide both long life and safety, 0.70≦x≦0.85 is more preferable.

As a range of y, 0.05≦y≦0.3 is given in the above general equation, because adopting y<0.05 and 0.3<y is not preferable, respectively; in the former range, the thermal stability of battery decreases and also the durability of charge/discharge cycle decreases, and in the latter range, the initial capacity of battery becomes small. It is more preferable to adopt the following range of y, 0.10≦y≦0.20, where Co allows for structure stabilization, so that better safety and excellent life characteristics can be provided with high capacity being maintained.

As a range of z, 0≦z≦0.2 is given in the above general equation. This intends to enhance an effect of additive elements and, at the same time, minimize the capacity reduction due to element addition. 0.005≦z is preferable to make an effect of additive elements develop better. Especially, with Al being used alone, 0.01≦z≦0.10 is preferable, and 0.02≦z≦0.07 is more preferable, because improvement in both safety and life performance can be achieved with capacity reduction being controlled as much as possible.

Furthermore, as a range of x+y+z, 0.95≦x+y+z≦1.05 is given in the above general equation. This is for the purpose of allowing for easy maintenance of the hexagonal system structure.

In the present invention, a battery is produced by use of the lithium-containing composite oxide represented by the general equation previously described, wherein a half width of the (110)-plane-based diffraction peak is larger than 0.13° and smaller than 0.20° and also the ratio of the (003)-plane-based diffraction peak intensity to the (104)-plane-based diffraction peak intensity is larger than 1.2 and smaller than 1.8.

The lithium-containing composite oxide having such characteristics can be synthesized by following, for example, the procedures described below.

First, hydroxide is synthesized by means of coprecipitation of nickel and cobalt. Specifically, such hydroxide can be obtained by mixing, for example, nickel sulfate and cobalt sulfate at a given composition, and adding sodium hydroxide solution to the mixed solution. Then, metallic compound other than nickel and cobalt is added to and mixed with this solution. When aluminum is added, aluminum hydroxide or aluminum oxide can be used mainly as aluminum compound, as well as aluminum chloride, aluminum sulfate, or aluminum nitrate. When magnesium is added, magnesium chloride, magnesium hydroxide, or magnesium carbonate can be used. When manganese is added, it is possible to use manganese dioxide, manganese carbonate, or manganese nitrate. When titanium is added, titanium oxide or titanium chloride can be used.

Next, lithium hydroxide is added and mixed, and the solution thus prepared is used as precursor. By burning this precursor at a temperature range of 650 to 850° C. for 3 to 20 hours under oxygen atmosphere, the desired lithium-nickel-cobalt composite oxide can be obtained. Concerning the burning temperature and time, it is possible to adjust them in measuring the crystalline quality of the obtained composite oxide; however, it is preferable to add a preliminary burning process prior to the burning process above described. In such a case, the burning time will be set shorter. For instance, when the precursor is preliminarily burned at 600° C. for 5 hours, the preferable burning time will be 5 to 10 hours with the burning temperature being a range of 700 to 750° C., and it will be shorter than 5 hours with the burning temperature being a range of 800 to 850° C. In addition, after the preliminary burning process and prior to the burning process previously described, it is preferable to add the grinding process of the burned precursor. The composite oxide thus obtained is grinded and then classified by size, preferably 5 to 20 μm, in order to improve electrode adhesion. Moreover, for the purpose of prolonging the life, preferable BET specific surface is considered 0.2-2.0 cm²/g.

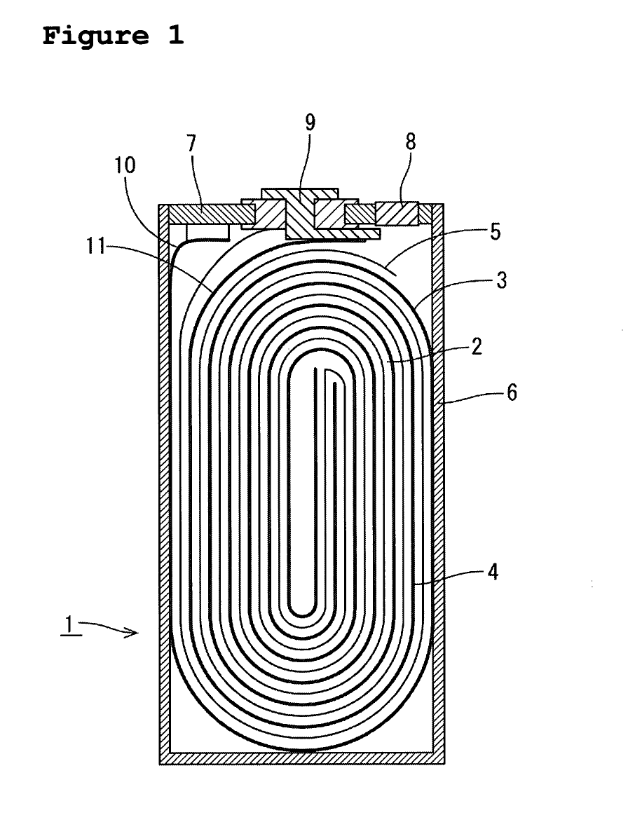

FIG. 1 shows an example of a non-aqueous electrolyte secondary battery which was manufactured using the lithium-containing composite oxide thus synthesized, as a positive active material. This non-aqueous electrolyte secondary battery 1 comprises a power-generating element 2 which is configured by winding a positive electrode 3 and a negative electrode 4 with a separator 5 therebetween, and a battery case 6 wherein said power-generating element 2 is housed together with non-aqueous electrolyte solution. The positive electrode 3 is formed by adding N-methyl-2-pyrrolidone to the positive electrode mixture which is prepared by mixing, for example, poly(vinylidene fluoride) as a binder, acetylene black as a conductive material, and lithium-containing composite oxide as a positive active material, making it to paste, applying this paste to the both surfaces of the current collector of strip aluminum foil, and drying them; and a positive reed 10 is connected to one end portion of said positive electrode 3. The negative electrode 4 is formed by adding N-methyl-2-pyrrolidone to the negative electrode mixture which is prepared by mixing, for example, graphite as a negative active material and poly(vinylidene fluoride) as a binder, making it to paste, applying this paste to the both surfaces of the current collector of strip copper foil, and drying them; and a negative reed 11 is connected to one end portion of said negative electrode 4.

To the battery case 6, a battery cap 7 equipped with a safety valve 8 is fixed by means of laser welding. And, a negative terminal 9 is connected with the negative electrode 4 through the negative reed 11, and the positive electrode 3 is connected with the battery cap 7 through the positive reed 10.

It is not intended that the configuration or manufacturing method of battery be limited to the description as set forth herein; therefore, manufacture can be implemented according to the ordinary manufacturing method using the negative active electrodes, electrolytes, and others which have been commonly used for non-aqueous electrolyte secondary batteries.

### EXAMPLE 1

1. Synthesis of Lithium-containing Composite Oxide

1) Synthesis of LiNi_{0.82}CO_{0.15}Al_{0.03}O₂

Nickel-cobalt coprecipitation hydroxide was prepared by dissolving nickel sulfate and cobalt sulfate at a given composition and then adding sodium hydroxide solution to this solution. Next, aluminum hydroxide was added to the solution thus prepared so that the ratio of the number of nickel, cobalt, and aluminum atoms, respectively, would be Ni:Co:Al=82:15:3. Subsequently, lithium hydroxide was added so that the ratio (Lit/Mt) of the number of lithium atoms (Lit) to the total number of the metal atoms other than lithium (Mt) would be 1.01. (The reason that the amount of Li is larger is that the amount of Li will be slightly reduced during burning process.)

After burned at 600° C. for 5 hours, this precursor was grinded and then burned at 750° C. for 10 hours under oxygen atmosphere; thus, the lithium-containing composite oxide represented by LiNi_{0.82}Co_{0.15}Al_{0.03}O₂ was obtained.

2) X-Ray Diffraction Analysis

For the LiNi_{0.82}Co_{0.15}Al_{0.03}O₂ thus synthesized, X-ray diffraction measurement was carried out by means of a RIGAKU RINT2400. With CuKα (a wave length λ=1.5405 Å) being used as a X-ray source, X-ray tube voltage and current were respectively set 50 kV and 200 mA, and a divergent slit of 1.0°, a scattering slit of 1.0°, and a receiving slit of 0.15 mm were adopted. The reflection angle was measured at a range of 10°≦θ≦100°, with the scan angle being measured at 0.04°. To the reflection peaks of the X-ray diffraction obtained, the processing of background cut-off and Kα2 removal was carried out. The removal of Kα2 peak was implemented at the rate of Kα2/Kα1=0.498.

2. Manufacture of a Non-Aqueous Electrolyte Secondary Battery

1) Formation of Positive Electrode

The LiNi_{0.82}Co_{0.15}Al_{0.03}O₂ obtained in the above section 1 was used as a positive active material. Poly(vinylidene fluoride) as a binder and acetylene black as a conductive material were mixed together with this positive active material in a weight ratio of positive active material: poly(vinylidene fluoride): acetylene black=88:8:4, and then a positive electrode mixture was prepared in a paste form. This paste was evenly applied to the both surfaces of the current collector of aluminum foil 20 μm thick, and this material was dried, pressed, and then cut to form a stripe positive sheet.

2) Formation of Negative Electrode

Graphite powder was used as a negative active material. Poly(vinylidene fluoride) as a binder was mixed together with this graphite in a weight ratio of graphite powder: poly(vinylidene fluoride)=92:8, and then a negative electrode mixture was prepared in a paste form. This paste was evenly applied to the both surfaces of the current collector of copper foil 10 μm thick, and then a stripe negative sheet was formed by following the same procedures as previously described for the positive sheet.

3) Preparation of Electrolyte Solution

Ethylene carbonate and diethyl carbonate were mixed at the volume ratio of 3:7 for the preparation of a non-aqueous solvent. The lithium chloride, as an electrolyte, LiPF₆ at a concentration of 1.2 mol/l was added to this non-aqueous solvent; thus, a non-aqueous electrolyte solution was prepared.

4) Manufacture of Battery

A power-generating element was configured by winding a material which was formed by laminating a positive electrode sheet, a polyethylene separator, a negative electrode sheet, and a polyethylene separator, in that order, and housed in a battery can of a prismatic shape. The electrolyte solution prepared in the above item 3) was then poured into the battery can, and the can was sealed with a battery cap equipped with an insulator, thereby producing a prismatic battery.

3. Charge/Discharge Cycle Test on Single Electrode of Positive Electrode

The LiNi_{0.82}Co_{0.15}Al_{0.03}O₂ obtained in the above section 1, acetylene black, and poly(vinylidene fluoride) were mixed together in a mortar in a weight ratio of positive active material: acetylene black: poly(vinylidene fluoride)=88:8:4, the mixture was applied to an aluminum-mesh current collector of 15 mm×15 mm, and this material was then pressed and served as an electrode for evaluation use. Evaluation was carried out by means of a three-electrode system using metal lithium as counter and reference electrodes. The electrolyte solution used was prepared by dissolving 1 mol/l of LiClO₄ with the mixed solvent in which the volume ratio of ethylene carbonate (EC) to diethyl carbonate (DEC) was 1:1.

Charge/discharge tests were implemented with the use of this single electrode of positive electrode according to the following conditions. The electrode was charged up to 4.3 V at a constant current of 1.0 mA/cm² and discharged down to 3.0 V at a constant current of 2.5 mA/cm²; this process was considered as one cycle and repeated 50 times. Then each discharge capacity at the 1^{st} cycle and the 50^{th} cycle was obtained, and the ratio of the discharge capacity at the 50^{th} cycle to that of the 1^{st} cycle was determined and taken as discharge capacity retention (%).

4. Charge/Discharge Cycle Test on Battery

At a temperature of 20° C. under atmosphere, the battery manufactured in the above section 2 was charged up to 4.1 V at a constant current of 400 mA, and charged continuously for 3 hours with maintaining a constant voltage of 4.1. After that, the battery was discharged down to 2.75 V at a constant current of 400 mA, and the discharge capacity was determined. This process was taken as one cycle, and charge/discharge operations were repeated until 300 cycles were attained. Thus obtained charge/discharge performance was evaluated by the ratio (discharge capacity retention) of the discharge capacity at the 300^{th} cycle to that of the 1^{st} cycle (initial discharge capacity).

### EXAMPLE 2

According to the preparation procedures identical to those of Example 1, except that the second burning temperature was 700° C., LiNi_{0.82}Co_{0.15}Al_{0.03}O₂ was obtained.

With the use of LiNi_{0.82}Co_{0.15}Al_{0.03}O₂, a battery was manufactured in the same manner as described in Example 1, and a similar test was conducted.

### EXAMPLE 3

According to the preparation procedures identical to those of Example 1, except that manganese dioxide was added instead of aluminum hydroxide to nickel-cobalt coprecipitation hydroxide, LiNi_{0.80}Co_{0.15}Mn_{0.50}O₂ was obtained.

With the use of LiNi_{0.80}Co_{0.15}Mn_{0.05}O₂, a battery was manufactured in the same manner as described in Example 1, and a similar test was conducted.

### EXAMPLE 4

According to the preparation procedures identical to those of Example 1, except that magnesium hydroxide was added instead of aluminum hydroxide to nickel-cobalt coprecipitation hydroxide, LiNi_{0.82}Co_{0.15}Mg_{0.03}O₂ was obtained.

With the use of LiNi_{0.82}Co_{0.15}Mg_{0.03}O₂, a battery was manufactured in the same manner as described in Example 1, and a similar test was conducted.

### COMPARATIVE EXAMPLE 1

According to the preparation procedures identical to those of Example 1, except that the second burning temperature was 600° C., LiNi_{0.82}Co_{0.15}Al_{0.03}O₂ was obtained.

With the use of LiNi_{0.82}Co_{0.15}Al_{0.03}O₂, a battery was manufactured in the same manner as described in Example 1, and a similar test was conducted.

### COMPARATIVE EXAMPLE 2

According to the preparation procedures identical to those of Example 1, except that the second burning temperature was 800° C. and the burning time was 20 hours, LiNi_{0.82}Co_{0.15}Al_{0.03}O₂ was obtained.

With the use of LiNi_{0.82}Co_{0.15}Al_{0.03}O₂, a battery was manufactured in the same manner as described in Example 1, and a similar test was conducted.

### COMPARATIVE EXAMPLE 3

According to the preparation procedures identical to those of Example 1, except that the second burning temperature was 750° C. and the burning time was 30 hours, LiNi_{0.82Co}_{0.15}Al_{0.03}O₂ was obtained.

With the use of LiNi_{0.82}CO_{0.15}Al_{0.03}O₂, a battery was manufactured in the same manner as described in Example 1, and a similar test was conducted.

### COMPARATIVE EXAMPLE 4

According to the preparation procedures identical to those of Example 1, except that the second burning temperature was 850° C. and the burning time was 10 hours, LiNi_{0.82}Co_{0.15}Al_{0.03}O₂ was obtained.

With the use of LiNi_{0.82}Co_{0.15}Al_{0.03}O₂, a battery was manufactured in the same manner as described in Example 1, and a similar test was conducted.

### COMPARATIVE EXAMPLE 5

According to the preparation procedures identical to those of Example 1, except that the second burning temperature was 850° C. and the burning time was 30 hours, LiNi_{0.82}Co_{0.15}Al_{0.03}O₂ was obtained.

With the use of LiNi_{0.82}Co_{0.15}Al_{0.03}O₂, a battery was manufactured in the same manner as described in Example 1, and a similar test was conducted.

### COMPARATIVE EXAMPLE 6

According to the preparation procedures identical to those of Example 1, except that the second burning temperature was 750° C. and the burning time was 25 hours, LiNi_{0.82}Co_{0.15}Al_{0.03}O₂ was obtained.

With the use of LiNi_{0.82}Co_{0.15}Al_{0.03}O₂, a battery was manufactured in the same manner as described in Example 1, and a similar test was conducted.

### COMPARATIVE EXAMPLE 7

According to the preparation procedures identical to those of Example 1, except that the second burning temperature was 600° C. and the burning time was 20 hours, LiNi_{0.82}Co_{0.15}Al_{0.03}O₂ was obtained.

With the use of LiNi_{0.82}Co_{0.15}Al_{0.03}O₂, a battery was manufactured in the same manner as described in Example 1, and a similar test was conducted.

### COMPARATIVE EXAMPLE 8

According to the preparation procedures identical to those of Example 1, except that the second burning temperature was 800° C., the burning time was 20 hours, and Ni:Co:Al=68:10:22, LiNi_{0.68}Co_{0.10}Al_{0.22}O₂ was obtained.

With the use of LiNi_{0.68}Co_{0.10}Al_{0.22}O₂, a battery was manufactured in the same manner as described in Example 1, and a similar test was conducted.

### COMPARATIVE EXAMPLE 9

Regarding the LiNi_{0.80}Co_{0.15}Mn_{0.05}O₂ synthesized in Example 3, according to the preparation procedures identical to those of Example 3, except that the second burning temperature was 800° C. and the burning time was 20 hours, LiNi_{0.80}Co_{0.15}Mn_{0.05}O₂ was obtained.

With the use of LiNi_{0.80}Co_{0.15}Mn_{0.05}O₂, a battery was manufactured in the same manner as described in Example 1, and a similar test was conducted.

Test Results

1. X-ray Diffraction Analysis

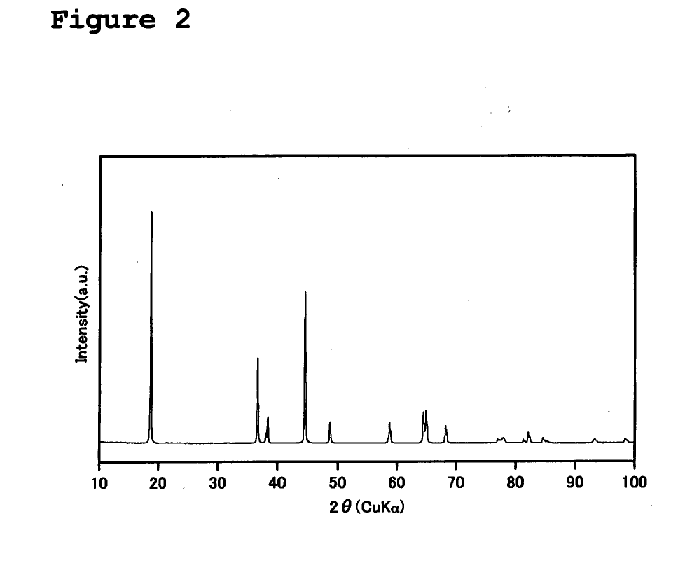

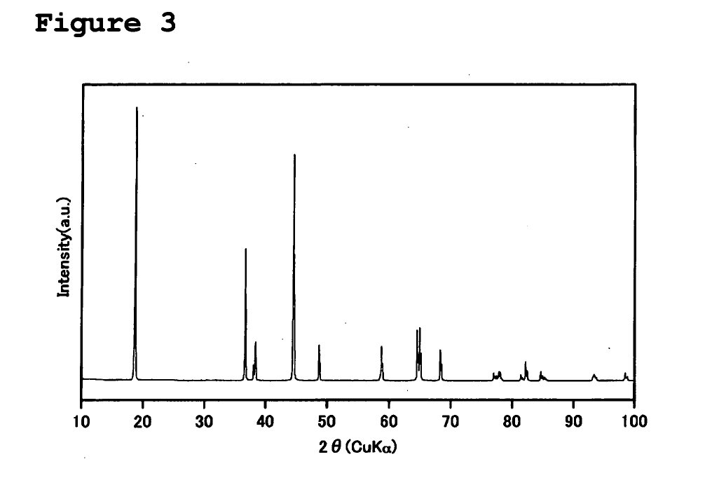

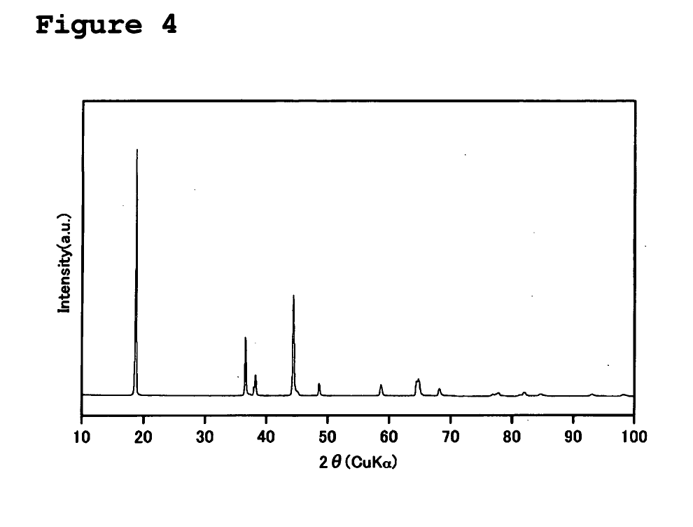

FIG. 2 shows a X-ray diffraction diagram of the LiNi_{0.82}Co_{0.15}Al_{0.03}O₂ which was synthesized in Example 1. Likewise, FIGS. 3 and 4 show X-ray diffraction diagrams of the LiNi_{0.82}Co_{0.15}Al_{0.03}O₂ in Comparative Example 1 and the LiNi_{0.82}Co_{0.15}Al_{0.03}O₂ in Comparative Example 2, respectively.

The results of X-ray diffraction analysis were summarized in Table 1. In Table 1, l(003)/l(104) represents the ratio of the (003)-plane-based X-ray diffraction peak intensity which appears in the range of 2θ=19±1° to the (104)-plane-based X-ray diffraction peak intensity which appears in the range of 2θ=45±1°, and “half width” represents a half width of the (110)-plane-based X-ray diffraction peak which appears in the range of 2θ=65±1°.

2. Cycle Life Test on Single Electrode of Positive Electrode

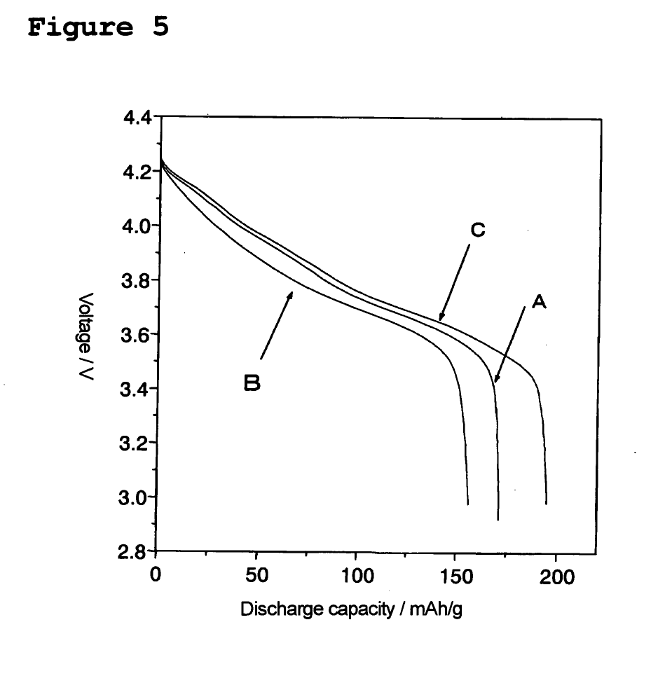

Table 2 shows the results of the test on single electrode of positive electrode, and FIG. 5 shows discharge curves at the 1^{st} cycle obtained from Example 1, Comparative Example 1, and Comparative Example 2, respectively. In FIG. 5, the letters A, B, and C denote the discharge curves of Example 1, Comparative Example 1, and Comparative Example 2, respectively. Moreover, it was noted that the discharge curves obtained from Examples 2 to 4 were almost the same as that of Example 1.

TABLE 1

| | Positive active material | I(003)/I(104) | Half width |
|---|---|---|---|
| Example 1 | LiNi_{0.82}Co_{0.15}Al_{0.03}O₂ | 1.41 | 0.14 |
| Example 2 | LiNi_{0.82}Co_{0.15}Al_{0.03}O₂ | 1.75 | 0.19 |
| Example 3 | LiNi_{0.80}Co_{0.15}Mn_{0.05}O₂ | 1.36 | 0.19 |
| Example 4 | LiNi_{0.82}Co_{0.15}Mg_{0.03}O₂ | 1.51 | 0.14 |
| Comp. Examp. 1 | LiNi_{0.82}Co_{0.15}Al_{0.03}O₂ | 1.09 | 0.23 |
| Comp. Examp. 2 | LiNi_{0.82}Co_{0.15}Al_{0.03}O₂ | 2.02 | 0.19 |
| Comp. Examp. 3 | LiNi_{0.82}Co_{0.15}Al_{0.03}O₂ | 1.93 | 0.12 |
| Comp. Examp. 4 | LiNi_{0.82}Co_{0.15}Al_{0.03}O₂ | 1.10 | 0.19 |
| Comp. Examp. 5 | LiNi_{0.82}Co_{0.15}Al_{0.03}O₂ | 1.02 | 0.14 |
| Comp. Examp. 6 | LiNi_{0.82}Co_{0.15}Al_{0.03}O₂ | 1.34 | 0.12 |
| Comp. Examp. 7 | LiNi_{0.82}Co_{0.15}Al_{0.03}O₂ | 1.55 | 0.24 |
| Comp. Examp. 8 | LiNi_{0.68}Co_{0.10}Al_{0.22}O₂ | 1.31 | 0.19 |
| Comp. Examp. 9 | LiNi_{0.80}Co_{0.15}Mn_{0.05}O₂ | 1.52 | 0.21 |

TABLE 2

| | Specific surface | Discharge capacity (mAh/g) | | |
|---|---|---|---|---|
| | area (m²/g) | Initial | 50^{th} cycle | Retention (%) |
| Example 1 | 0.47 | 172 | 166 | 96.5 |
| Example 2 | 0.39 | 179 | 172 | 96.1 |
| Example 3 | 0.40 | 171 | 161 | 94.2 |
| Example 4 | 0.47 | 174 | 165 | 94.8 |
| Comp. Examp. 1 | 0.34 | 156 | 114 | 73.1 |
| Comp. Examp. 2 | 0.71 | 185 | 154 | 83.3 |
| Comp. Examp. 3 | 0.68 | 182 | 159 | 87.4 |
| Comp. Examp. 4 | 0.45 | 177 | 152 | 85.9 |
| Comp. Examp. 5 | 0.52 | 171 | 145 | 84.7 |
| Comp. Examp. 6 | 0.46 | 185 | 126 | 68.0 |
| Comp. Examp. 7 | 0.49 | 166 | 152 | 91.8 |
| Comp. Examp. 8 | 0.82 | 135 | 113 | 83.7 |
| Comp. Examp. 9 | 0.60 | 163 | 140 | 86.1 |

3. Cycle Life Test on Battery

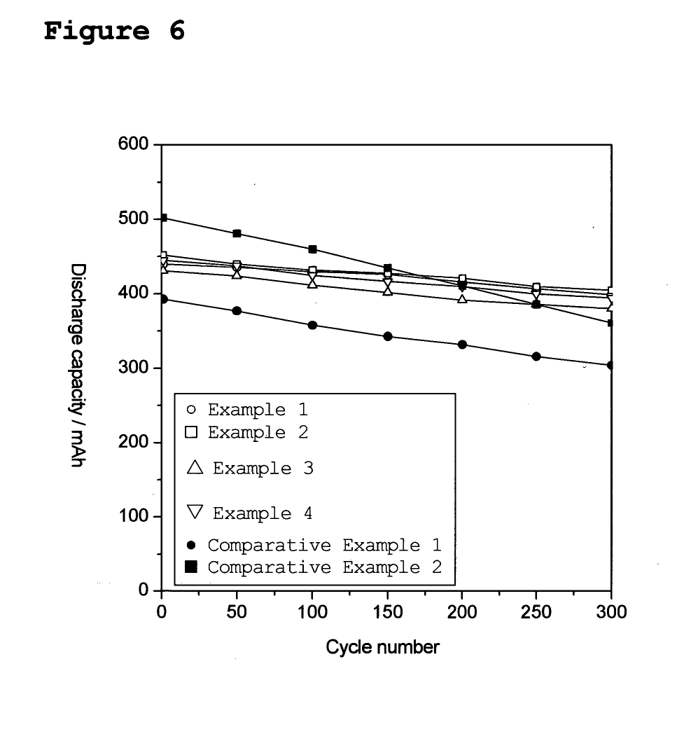

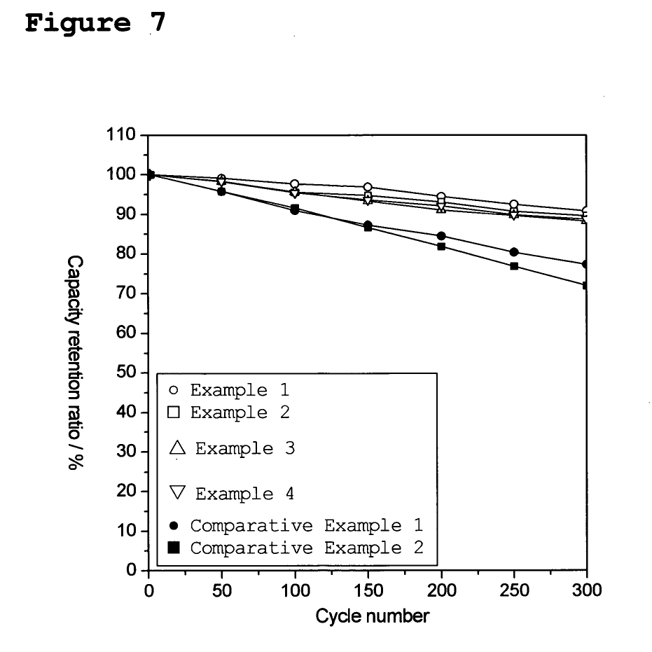

The results of cycle test on non-aqueous electrolyte secondary batteries of Examples 1 to 4 and Comparative Examples 1 and 2 were plotted on FIGS. 6 and 7. FIG. 6 shows the relationship between the number of charge/discharge cycles and discharge capacity, and FIG. 7 shows the relationship between the number of charge/discharge cycles and discharge capacity retention. In FIGS. 6 and 7, those symbols ∘, □, Δ, ∇, ●, and ▪ denote Examples 1, 2, 3, and 4, and Comparative Examples 1 and 2, respectively.

In Examples 1 and 2, a half width of the (110)-plane-based diffraction peak lies in the range larger than 0.13° and smaller than 0.20°, and l(003)/l(104) lies in the range larger than 1.2 and smaller than 1.8. In contrast to them, Comparative Examples 1 to 7 satisfy either or neither of the above two conditions. Furthermore, the batteries of any Examples have such high retention as 94% and over, and in comparison with them, those of Comparative Examples have lower retention in any cases.

The above findings are only one example; however, when a half width of the (110)-plane-based diffraction peak lies in the range larger than 0.13° and smaller than 0.20°, preferably in the 0.14° to 0.19° range, and l(003)/l(104) lies in the range larger than 1.2 and smaller than 1.8, high capacity retention can be achieved.

In addition, as shown in Examples 3 and 4, even when the substitution element is changed, if the above conditions are satisfied, high capacity retention can be achieved.

Moreover, although Comparative Example 8 satisfies the above both conditions, the capacity is small and the retention is low. This is attributed to the percentage of Al substitution exceeding 20%. For instance, when the substitution percentage of Co lies from 5 to 30%, and when the substitution percentage of an element such as Al is less than 20%, high capacity retention can be achieved provided that the above two conditions are satisfied.

Industrial Applicability

According to the present invention, it is possible to manufacture a non-aqueous electrolyte secondary battery which has high capacity and excellent cycling characteristics.

1. A non-aqueous electrolyte secondary battery comprising a positive electrode which is configured by applying on a current collector a mixture which comprises:
a lithium-containing composite oxide having a hexagonal system structure, wherein Co is substituted for part of nickel atoms in the crystal lattice in a lithium-nickel composite oxide which is represented by a general equation, LiNiO₂, (provided that the substitution percentage ranges from 5% to 30% of the number of nickel atoms in said lithium-nickel composite oxide) and, in addition, at least one element which is selected from a group consisting of Al, Mn, Ti, and Mg is substituted (provided that the substitution percentage is less than 20% of the number of nickel atoms in said lithium-nickel composite oxide),
a binder, and
a conductive material;
wherein said lithium-containing composite oxide is characterized in that a half width of the (110)-plane-based diffraction peak obtained from powder X-ray diffraction method, in which CuKα line is used as characteristic X-ray, is larger than 0.13° and smaller than 0.20° and that the ratio of the (003)-plane-based diffraction peak intensity to the (104)-plane-based diffraction peak intensity is larger than 1.2 and smaller than 1.8.

2. The non-aqueous electrolyte secondary battery according to claim 1, wherein said lithium-containing composite oxide is represented by the general equation, Li_{w}NiₓCo_{y}M_{z}O₂, (provided that M is at least one element which is selected from Al, Mn, Ti, or Mg, 0<w≦1.2, 0.95≦x+y+z≦1.05, 0.5≦x≦0.9, 0.05≦y≦0.3, and 0<x≦0.2.)

3. The non-aqueous electrolyte secondary battery according to claim 1, wherein said lithium-containing composite oxide is represented by the general equation, Li_{w}NiₓCo_{y}Al_{z}O₂, (provided that 0<w1.2, 0.95≦x+y+z≦1.05, 0.7≦x≦0.85, 0.1≦y≦0.2, and 0.01<z≦0.1.)
